(19) United States
(12) Patent Application Publication
(10) Pub. No.: US 2002/0122223 A1
(43) Pub. Date: Sep. 5, 2002

(54) Data path architecture for light layer 1 OEO switch

(76) Inventors: Denis Gallant, Dunrobin (CA); Ling-Zhong Liu, Ottawa (CA); Don Asquin, Ottawa (CA)

Correspondence Address: MARKS & CLERK, P.O. BOX 957, STATION B, OTTAWA, ON, K1P 5S7, CA

(21) Appl. No.: 10/085,086

(22) Filed: Mar. 1, 2002

Related U.S. Application Data
(60) Provisional application No. 60/272,448, filed on Mar. 2, 2001.

(51) Int. Cl. H04B 10/08; H04J 14/00

(52) U.S. Cl. 359/110; 359/117

(57) ABSTRACT

The light layer 1 OEO data path system architecture of the present invention provides a solution to the data opaqueness (i.e. protocol and data rate specific) of traditional OEO optical cross-connect switches (e.g. SONET/SDH OXC) and the full optical transparency issues of all optical photonic switches. More specifically, the documented light layer 1 OEO data path system architecture of the invention solves numerous identified problems for SONET/ISDH OEO cross-connect and all optical photonic switches.

This invention claims the benefit of U.S. Provisional application No. 60/272,448 filed Mar. 2, 2001.

### FIELD OF THE INVENTION

This invention relates to communications networks, and in particular to the design of switching equipment for such networks.

### BACKGROUND

In communications networks, and in particular networks incorporating optical transmission links, it is known to employ protocol-specific optical-electrical-optical (OEO) switches (e.g. SONET/SDH {Synchronous Optical Network}/{Synchronous Digital Hierarchy} optical cross-connect) and/or all-optical (OOO)switches (e.g. photonic cross-connect). Traditional OEO switches such as SONET/SDH have data-rate and protocol-specific line cards and switching fabric. All-optical photonic switches typically have full optical transparent line cards (i.e. no electrical conversion takes place) and switching fabrics such as MEMS (Micro-Electromechanical Systems).

Current or traditional OEO switches, such as SONET/SDH optical cross-connects, have some major limitations, such as:

a) Data signal rate dependence (e.g. SONET/SDH rates only); and

b) Data signal protocol dependence (e.g. SONET/SDH protocols only).

Current OOO switches (e.g. all-optical photonic cross-connects) also have some major limitations:

a) Difficulty detecting link failures;

b) Lack of detailed performance monitoring and diagnostics;

c) Lack of data integrity monitoring across switching fabric planes;

d) Difficulty implementing fabric redundancy;

e) Difficulty implementing line loopbacks; and

f) Difficulty implementing fabric loopbacks

### SUMMARY OF THE INVENTION

The light layer 1 OEO data path system architecture of the present invention provides a solution to the opaqueness (i.e. data signal protocol and rate dependence) of traditional 3R (i.e. re-shape, re-time, re-amplify) OEO switches, and to the full optical transparency of OOO switches, as described above. More specifically, the data path system architecture documented below resolves all of the limitations of OEO and OOO switches by providing:

a) Data signal rate independence;

b) Data signal protocol independence;

c) Detection of link failures;

d) Detailed performance monitoring and diagnostics;

e) Data integrity across both switching fabric planes;

f) Active and back-up fabric selection;

g) Line loopback; and

h) Fabric loopback.

Therefore in accordance with a first broad aspect of the present invention there is provided a transparent data path architecture for an optical-electrical-optical (OEO) switch comprising: means to recover a data rate from an incoming serial signal; means to monitor signal quality of the incoming signal; and means to provide data integrity across the transparent switching fabric.

In accordance with a second broad aspect of the invention there is provided a method of providing data integrity of a serial data signal through a transparent data path architecture of an optical-electrical-optical (OEO) switch, the method comprising: providing means to recover a data rate from the incoming serial data signal; providing means to switch the signal across a switching fabric, the switching fabric including an active fabric and a back-up fabric; monitoring signal quality of the signal across respective switching fabrics; and selecting the signal across respective switching fabrics having a higher signal quality.

### BRIEF DESCRIPTION OF THE DRAWINGS

The invention will now be described in greater detail with reference to the attached drawings wherein

FIG. 1 illustrates the data path architecture for a light layer 1 OEO switch;

FIG. 2 illustrates a split-and-monitor mode for detailed performance monitoring of the data stream;

FIG. 3 illustrates the performance monitoring module functional block details;

FIG. 4 illustrates data integrity monitoring across the switch fabric planes;

FIG. 5 illustrates line loopback; and

FIG. 6 illustrates switch fabric loopback.

### DETAILED DESCRIPTION OF THE INVENTION

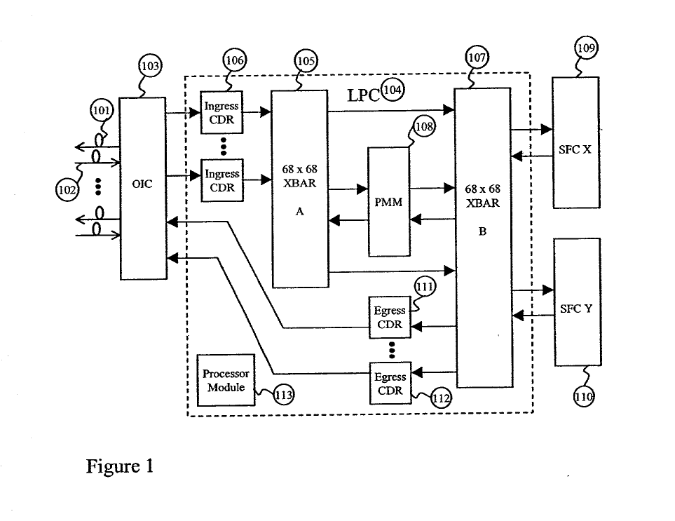

FIG. 1 shows the data path system architecture for a light layer 1 OEO switch. A light layer 1 implies that the data signals are only handled at the bit level through the system (i.e. no framing and processing of layer 1 takes place in the data path). The following sections outline the design solutions (a to h) described in the previous section.

a) Data Signal Rate Independence

Refer to FIG. 1. The data signal rate independence of the system design is provided by using an Ingress clock and data recovery (CDR) circuit 106 on the receive side, as shown in FIG. 1. The Ingress CDR, in conjunction with the Processor Module 113, is capable of automatically detecting and locking onto any bit rate within a range. Once locked, the data rate is then propagated to other devices along the data path as required by the Processor Module 113.

b) Data Signal Protocol Independence

Refer to FIG. 1. Data signal protocol independence is provided by staying at the bit level throughout the data path (i.e. from optical input to optical output). Framing, overhead, parity etc. are not required because the data is treated strictly as a string of 1s and 0s.

c) Detection of Link Failures

Refer to FIG. 1. Link failures are monitored and detected by the Ingress CDR 106. The Ingress CDR 106 is designed with built-in monitoring capabilities. In addition to the standard alarms for loss-of-signal and loss-of-lock, the CDR can also monitor the data eye pattern opening. The Processor Module 113 monitors the state of the Ingress CDR 106 device for alarms and data eye pattern opening information. The Processor Module 113 can correlate data eye pattern opening to an equivalent bit error rate. How the Processor Module 113 correlates the data eye pattern opening information with an equivalent bit error rate is beyond the scope of this invention. If the rate exceeds a user-definable threshold (e.g. 10-8), the processor declares a link failure.

d) Detailed Performance Monitoring and Diagnostics

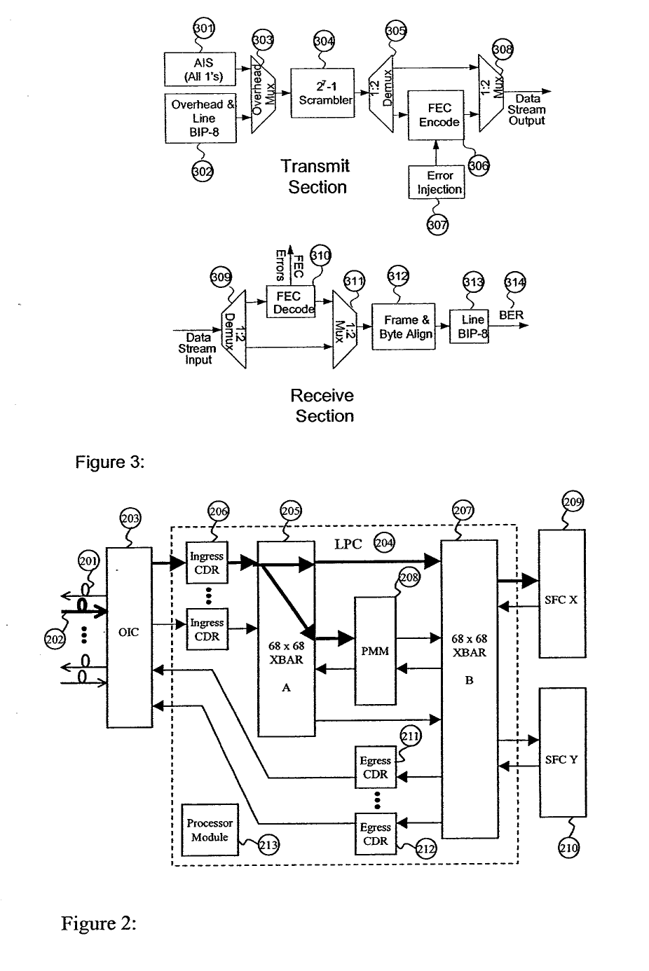

Refer to FIG. 2. For detailed performance monitoring and diagnostics, the system architecture includes a Performance Monitoring Module (PMM) 208 on each Line Processing Card (LPC) 204. The PMM 208 is designed to monitor and process the layer 1 (and in some cases layer 2) overhead of multiple data signal protocols (e.g. SONET/SDH, Ethernet) and data signal rates. Optical data from the ingress fiber optic 202 is translated into an electrical signal in the Optical Interface Card (OIC) 203. The electrical signal is routed through the Ingress CDR 206, to the 68×68 Crossbar A (×BAR) 205, and then into the PMM 208. For active user data paths, the PMM 208 is attached to the data path in a split-and-monitor mode. The split-and-monitor mode is accomplished by using the non-intrusive multicast capability of the fabric hardware.

FIG. 3 shows the major functional blocks in the PMM. In the receive path PMM, FEC (Forward Error Correction) coding is optionally decoded and FEC errors are detected through a 1:2 Demultiplexer (Demux) 309, 1:2 Multiplexer (Mux) 311 and a FEC Decoder 310. The SONET frame is then Frame and Byte Aligned 312, and the Bit Error Rate (BER) 314 detected through errors in the line BIP-8 (Bit Interleaved Parity 8) 313.

For non-active user data paths (idle, unused, loopback etc.) that do not have an active data signal, the PMM can be used to either transmit or receive data. As a transmitter, the PMM can generate a specific SONET payload that can be used to determine the quality of the connection. FIG. 3 shows an all is line Alarm Indication Signal (AIS) 301 being multiplexed 303 with the SONET overhead and line BIP-8 302. The resulting data pattern is scrambled in a 27-1 scrambler 304. The scrambled data can optionally have FEC added through a 1:2 Demultiplexer (Demux) 305, a 1:2 Multiplexer (Mux) 308 and a FEC Encoder 306. Errors can be injected 307 into the FEC. The test data stream is be routed out the 68×68 Crossbar B (×BAR) to the Switch Fabric Card (SFC). From the SFC the test pattern can be looped back to the same LPC and PMM or it can be routed to a second LPC and PMM in the same shelf or anywhere on the fiber network.

In the receive path PMM, the test data stream is treated as the active data stream. FEC coding can be optionally decoded and FEC errors detected through a 1:2 Demultiplexer (Demux) 309, 1:2 Multiplexer (Mux) 311 and a FEC Decoder 310. The SONET frame is then Frame and Byte Aligned 312, and the Bit Error Rate (BER) 314 is detected through errors in the line BIP-8 313. This determines the error rate of the test signal, and indicates to the user if there is a problem with one of the components (switch fabric, laser, fiber, receiver etc.) in the connection path. Line BIP-8 is a standard method of error detection in a SONET network.

e) Data Integrity Across Both Switching Fabric Planes

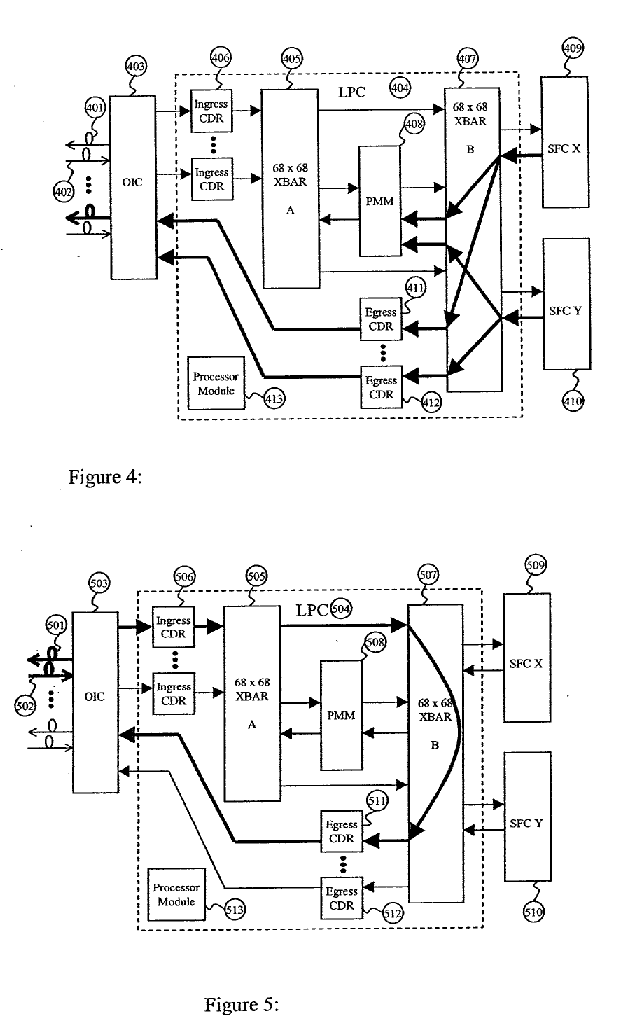

In FIG. 4, the status of the data signals from the switching fabric planes of the SFC X 409 and Y 410 can be monitored in several ways. If the SFC is carrying a known data signal protocol such as SONET/SDH or Ethernet, then detailed performance monitoring may be performed by the PMM 408 as described monitoring capabilities in the section above. If the data signal protocol is unknown, then the built-in monitoring capabilities of the Egress CDRs 411, 412 are used. In addition to the standard alarms for loss-of-signal and loss-of-lock, the CDR can also monitor the data eye pattern opening. The Processor Module 413 monitors the state of the Egress CDR 411, 412 devices for alarms and data eye pattern opening information. The Processor Module 413 can correlate data eye pattern opening to an equivalent bit error rate. The performance of the two SFCs X 409 and Y 410 can be compared, and the one with the best error performance is chosen. The Processor Module 413 will also report, via alarm messages, any changes in the health of the data signals from the active and backup SFCs 409,410 to the main system control and management system.

f) Active and Back-up Fabric Selection

In FIG. 4, the Processor Module 413 will read the alarms and status signals (e.g. loss-of-lock and loss-of-signal, eye pattern opening, FEC errors, line BIP-8 errors) from the Egress CDRs 411, 412 and PMM 408, and will make a determination of which data signal from SFC X 409 or Y 410 is healthiest. The algorithm for determining the currently active data signal is not the subject of this invention, and may involve other parameters not discussed here. The Processor Module 413 will choose which SFC 409, 410 data signal to forward to the OIC 403 for transmission on the egress fiber optic 401.

g) Line Loopback

Refer to FIG. 5. The optical signal on the ingress fiber optic 502 is converted to an electrical signal in the OIC 503 and passed through the Ingress CDR 506. The 3R version of the signal (re-shaped, re-amplified, and re-timed) is passed to the 68×68 Crossbar A (×BAR) 505, then to the 68×68 Crossbar B (×BAR) 507. In the 68×68 Crossbar B (×BAR) 507 the signal is looped back to the Egress CDR 511, then to the OIC 503, where it is converted to an optical signal and transmitted over the egress fiber optic 501. The Processor Module 513 controls the line loopback.

h) Switch Fabric Loopback

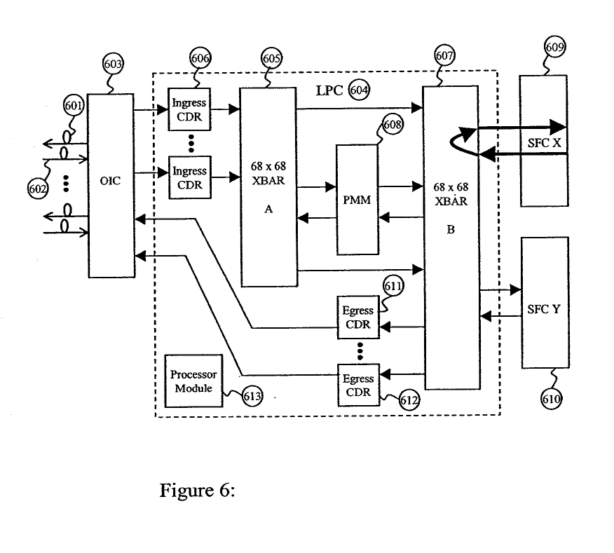

Refer to FIG. 6. The electrical data signal from a SFC X 609 is sent to the 68 ×68 Crossbar B (×BAR) 607. Within the 68×68 Crossbar B (×BAR) 607, the data signal is looped back and sent through the SFC X 609. The Processor Module 613 controls fabric loopback. Any of the SFCs in the system may be looped back in a similar way.

Although particular embodiments of the invention have been described and illustrated, it will be apparent to one skilled in the art that numerous changes can be made without departing from the basic concept. It is to be understood, however, that such changes will fall within the full scope of the invention as defined by the appended claims.

We claim:

1. A transparent data path architecture for an optical-electrical-optical (OEO) switch comprising:
means to recover a data rate from an incoming serial signal;
means to monitor signal quality of the incoming signal; and
means to provide data integrity across the transparent switching fabric.

2. The transparent data path architecture as defined in claim 1 wherein said architecture is independent of input data rate.

3. The transparent data path architecture as defined in claim 2 having means to switch an incoming signal independent of data protocol.

4. The transparent data path architecture as defined in claim 3 wherein said means to recover a data rate from an incoming signal is capable of recovering a data rate from a wide range of data rates.

5. The transparent data path architecture as defined in claim 1 having means to switch a signal across said switch without modifying the data signal by adding data bits.

6. The transparent data path architecture as defined in claim 1 having means to switch a signal across said switch without modifying the data signal by changing data bits.

7. The transparent data path architecture as defined in claim 1 having means to switch a signal across said switch without modifying the data signal by deleting data bits.

8. The transparent data path architecture as defined in claim 1 having means to extract layer-1 performance data from the incoming signal in a non-intrusive manner.

9. The transparent data path architecture as defined in claim 1 having means to extract layer-1 and layer-2 performance data from the incoming signal in a non-intrusive manner.

10. The transparent data path architecture as defined in claim 1 having an active switching fabric plane and a back-up switching fabric plane.

11. The transparent data path architecture as defined in claim 10 wherein data integrity is monitored across the active switching fabric plane and the back-up switching fabric plane.

12. The transparent data path architecture as defined in claim 11 having means to select between said active switching plane and said back-up switching plane based on quality of data integrity between said switching fabric planes.

13. The transparent data architecture as defined in claim 1 having means to provide line loopback of a signal having undergone re-shaping, re-amplification and re-shaping in a clock data recovery unit.

14. The transparent data architecture as defined in claim 1 having means to provide loopback functionality wherein a signal is looped back through either the active switching fabric plane or the back-up switching fabric plane.

15. A method of providing data integrity of serial data signal through a transparent data path architecture of an optical-electrical-optical (OEO) switch, the method comprising:
providing means to recover a data rate from said incoming serial data signal;
providing means to switch a signal across a switching fabric, the switching fabric including an active fabric and a back-up fabric;
monitoring signal quality of the signal across respective switching fabrics; and
selecting the signal across respective switching fabrics having a higher signal quality.

16. The method as defined in claim 15 wherein said transparent architecture is independent of data rate and data protocol.
A data rate and protocol independent data path architecture for an optical-electrical-optical (OEO) switch comprising:
means to recover a range of signal data rates from an incoming serial signal;
means to switch any signal, independent of data protocol;
means to switch any signal across the switch without modifying the data signals;
means to monitor signal quality of the incoming signal, independent of data rate or protocol;
means to extract layer 1 and 2 performance data from the signal in a non-intrusive manner; and
means to provide data integrity across the transparent switching fabric.
